(19) United States
(12) Patent Application Publication
(10) Pub. No.: US 2012/0005441 A1
(43) Pub. Date: Jan. 5, 2012

(54) COPYING APPARATUS, COPYING METHOD, MEMORY MEDIUM, AND PROGRAM

(75) Inventors: Naomichi TOMITA, Shizuoka (JP); Toshihiko Senno, Kanagawa (JP)

(73) Assignees: SONY DADC CORPORATION, Shinagawa-ku (JP); Sony Corporation, Tokyo (JP)

(21) Appl. No.: 13/108,202

(22) Filed: May 16, 2011

(30) Foreign Application Priority Data
Jun. 30, 2010 (JP) 2010-148605

(51) Int. Cl. G06F 12/16

(52) U.S. Cl. 711/162; 711/E12.103

(57) ABSTRACT

A copying apparatus is used for copying data stored in a memory medium including a memory unit storing the data therein and having a management data area in which unique information of the memory medium is stored and a user data area into which user data is written, as a master medium to the memory medium as a copy destination medium. The copying apparatus includes: a memory means for storing an image data file of the master medium and the unique information that is stored in the management data area of the master medium therein; a reading/writing unit that writes or reads data on or from the installed copy destination medium; and a control unit that is configured so as to perform a necessary control process by operating an operating system based on an application program. The control unit performs a file/folder recognizing process and a writing control process.

### BACKGROUND OF THE INVENTION

1. Field of the Invention

The present invention relates to a memory medium including a memory unit that stores data therein, and more particularly, to a copying apparatus that copies data stored in the memory medium as a master medium to the memory medium as a copy destination medium and a method thereof. In addition, the present invention relates to a memory medium of which data is copied by using the above-described copying method and a program to be executed by the copying apparatus.

2. Description of the Related Art

Package media such as DVDs (Digital Versatile Discs), and BDs (Blu-ray Discs: registered trademark) having video contents such as movies stored thereon are widely sold.

Recently, as a special item (bonus item) or the like of such a package medium, a memory card (for example, an SD card, a micro SD card, or the like) having contents such as videos stored thereon is added to the package medium so as to be sold.

The memory card as such a special item or the like is generated by, first, recording a video content generated through authoring in a memory card as a master and copying the recording content to memory cards as copy destinations by using a copying apparatus using the memory card as the master.

Here, as specific copying techniques when the memory cards as the special items or the like are produced on a large scale by copying the stored data of the memory card as the master, for example, the techniques described below may be considered.

1) A technique in which only folders and files are extracted from the memory card as the master so as to be archived by using archive software (organized as one file such as zip or tar), the archive is expanded in a high-speed storage device such as an SSD (Solid State Drive) immediately before a copying process, and data is copied from the high-speed storage device to the copy destination media.

According to the technique of 1), the data expanded in the high-speed storage device can be copied to the memory cards as the copy destinations, and therefore a high-speed copying operation can be realized.

However, in this technique of 1), since the file is placed in the storage device in the state of being expanded for a relatively long time, there is a problem in that the risk of virus infection of the content data to be copied to the copy destination is increased.

At this time, although a virus protective countermeasure may be considered to be taken, when such a protective countermeasure is taken, the system is complicated, and there is a concern that the copy speed will decrease.

In addition, according to the technique of 1), recording is performed in units of files and folders. Accordingly, the process burden of additionally generating file system information or the like to be recorded in the memory card is necessary when a copying operation is performed, and therefore the time for the copying operation increases accordingly.

Furthermore, only a part of date data may be stored depending on the archive software, and there is a possibility that it is necessary to additionally store the data.

2) A technique in which data is copied to a memory card as a copy destination while the data is read out from a memory card as a master.

By directly reading out data from the memory card as the master and copying (temporarily storing the data in a memory of the copying apparatus) the data to the memory card as the copy destination, the possibility of virus infection is extremely low.

However, according to the technique of 2), in a case where the data is simultaneously copied to a plurality of memory cards, the copy speed decreases, and there is a concern that the copy speed decreases depending on the transmission rate of the memory card as the master or the performance of a reading device.

Furthermore, in a case where a plurality of copying apparatuses are used so as to achieve the production number of the products, it is necessary to generate a plurality of memory cards as the masters, and it may be necessary to physically handle the memory cards as the masters.

3) A technique in which the content of the master medium is extracted as an image data file so as to be stored in a necessary medium such as a DVD, the image data file is arranged in a high-speed storage device included in a copying apparatus immediately before the copying operation, and the image data file is directly copied to the memory card of each copy destination.

Since the image data file is directly written into each memory card from the high-speed storage device, the copying operation can be performed at the highest speed. In addition, since the data to be written into each card is placed in the high-speed storage device immediately before the copying operation, the possibility of virus infection is low.

### SUMMARY OF THE INVENTION

However, since the above-described technique of 3) is a technique of directly copying the image data file of the memory card as the master, in a case where the memory capacities of the master medium and the copy destination medium are different from each other by only one byte, there is a problem in that it is difficult to appropriately perform a copying operation.

For example, in a case where the memory capacity of the memory card as the copy destination is smaller than that of the memory card as the master, there is a problem in that it is difficult to perform a copying operation even in a case where the content can be copied in terms of the capacity.

On the other hand, even in a case where the memory capacity of the memory card as the copy destination is larger than that of the memory card as the master, file system information included in the image data file is generated in correspondence with a master having a small memory capacity. Accordingly, the memory card as the copy destination to which the image data file is copied is handled as if there is a memory area therein that is not recognized even in a case where data can be actually written therein.

In addition, in this case, the memory capacity information written in the file system information and the memory capacity information stored in the management data area (an area, in which card-specific information is stored, that is not rewritable) of the memory card do not coincide with each other. Such a case is handled as a violation of the specifications according to the reproduction system (the operating system or the application software) of the memory card. As a result, there is a concern that the reproduction of the memory card may be in a non-reproducible state.

There is a case where the memory card media such as SD cards may have different memory capacities of the flash memory units that are included therein due to a difference in the production lot (a difference in procurement destinations) even though they are the same products manufactured by the same manufacturer.

Accordingly, the above-described problems may occur even in a case where products that are manufactured by the same manufacturer and are regarded as having the same capacity are purchased as the memory cards that are used as the master copy destinations for manufacturing the above-described special items.

Thus, it is desirable that, in a case where memory medium products to which the content stored in a memory medium such as a memory card, for example, as a master medium is copied are manufactured on a large scale or the like, an appropriate copying operation can be performed even in a case where the memory capacities of the master media and the memory medium as the copy destination are different from each other, and the copying operation can be performed at a high speed.

According to an embodiment of the present invention, there is provided a copying apparatus that is used for copying data stored in a memory medium, which includes a memory unit storing the data therein and has a management data area in which unique information of the memory medium is stored and a user data area into which user data is written, as a master medium to the memory medium as a copy destination medium. The copying apparatus includes a memory means for storing an image data file of the master medium and the unique information that is stored in the management data area of the master medium therein.

In addition, the copying apparatus includes a reading/writing unit that writes or reads data on or from the loaded copy destination medium.

Furthermore, the copying apparatus includes a control unit that is configured so as to perform a necessary control process by operating an operating system based on an application program.

The control unit performs a file/folder recognizing process that allows data included in the image data file, which is stored by the memory means, to be recognized so as to be able to be handled by the operating system in units of files and folders and a writing control process in which the writing/reading unit reads out the unique information stored in the management data area of the copy destination media, and image file writing control in which the image data file is controlled so as to be written on the copy destination medium or writing control in units of files and folders in which the data included in the image data file is written onto the copy destination medium in units of the files and the folders recognized by the operating system through the file/folder recognizing process is selectively performed based on a result of comparison between the read-out unique information of the copy destination medium and the unique information of the master medium that is stored in the memory means.

As described above, according to the embodiment of the present invention, the image data file of the master medium and the medium-unique information are stored together, and the data included in the image data file is recognized so as to be able to be handled in units of files and folders by the operating system.

Moreover, based on a result of comparison between the medium-unique information stored in the copy destination medium and the medium-unique information of the master medium, image file writing control in which the image data file is controlled so as to be written on the copy destination medium or writing control in units of files and folders in which the data included in the image data file is written onto the copy destination medium in units of the files and the folders recognized by the operating system through the file/folder recognizing process is selectively performed.

According to the embodiment of the present invention, the image data file is directly copied in a case where the memory capacities of the master medium and the copy destination medium coincide with each other. On the other hand, in a case where the memory capacities of the master medium and the copy destination medium are different from each other, the data include in the image data file is copied in units of files and folders.

Therefore, even in a case where the memory capacities of the master and the copy destination are different from each other, a copying operation can be appropriately performed.

In addition, according to the copying technique of the embodiment of the present invention, the copy speed does not depend on the data transmission rate of the master medium or the speed of the reading device unlike the general technique 2), and a copying operation can be performed at a high speed in the view point.

According to the embodiment of the present invention, even in a case where the memory capacities of the master medium and the copy destination medium are different from each other, an appropriate copying operation can be performed, and the high-speed of the copying operation can be maintained.

### BRIEF DESCRIPTION OF THE DRAWINGS

FIG. 1 is a diagram illustrating the overview of a technique for producing a copy medium according to an embodiment.

FIG. 2 is a diagram representing an example of the internal configuration of a master medium and a copy destination medium.

FIG. 3 is a diagram representing an example of the internal configuration of a computer for generating an image file.

FIG. 4 is a diagram representing an example of the internal configuration of a writing/reading unit (reader/writer) that is included in a copying apparatus according to an embodiment.

FIG. 5 is a diagram representing an example of the internal configuration of an information processing device (control unit) that is included in a copying apparatus according to an embodiment.

FIG. 6 is a diagram illustrating a file/folder recognizing process for an image data file.

FIG. 7 is a diagram illustrating a writing control technique according to an embodiment.

FIG. 8 is a flowchart illustrating a detailed flow of the process to be performed when necessary information such as an image data file of a master medium is generated.

FIG. 9 is a flowchart illustrating a detailed flow of the process to be performed by a copying apparatus according to an embodiment.

FIG. 10 is a flowchart illustrating a detailed flow of the process to be performed by the copying apparatus according to an embodiment.

FIGS. 11A and 11B are diagrams illustrating a modified example relating to a configuration that is used for copying data into a plurality of memory media in a parallel manner.

### DESCRIPTION OF THE PREFERRED EMBODIMENTS

Hereinafter, preferred embodiments of the present invention (hereinafter, referred to as embodiments) will be described.

The description will be presented in the following order.

<1. Overview of Technique for Producing Copy Medium according to Embodiment>

<2. Internal Configuration of Each Unit>

[2-1. Internal Configuration of Memory Medium]

[2-2. Internal Configuration of Computer for Generating Image file]

[2-3. Internal Configuration of Writing/Reading Unit Included in Copying Apparatus according to Embodiment]

[2-4. Internal Configuration of Control Unit Included in Copying Apparatus according to Embodiment]

<3. Copying Method according to Embodiment>

<4. Processing Flow>

<5. Statistics of Embodiment>

<6. Modified Examples>

### 1. Overview of Technique for Producing Copy Medium according to Embodiment

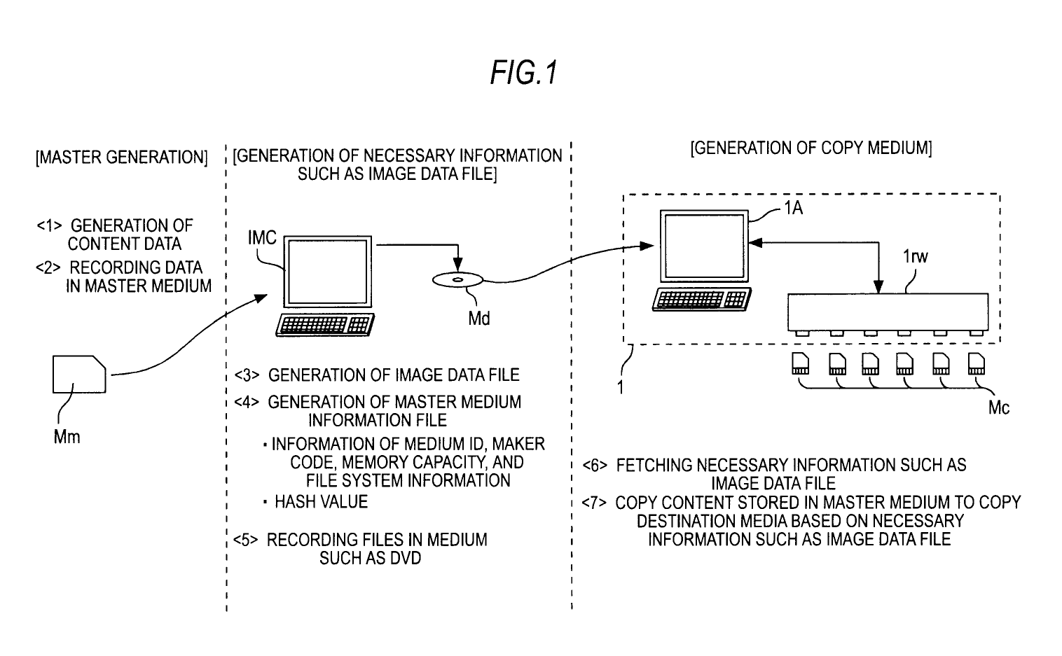

FIG. 1 is a diagram illustrating the overview of a technique for producing a copy medium according to an embodiment.

The technique for producing a copy medium according to this embodiment can be broadly divided into a master generating process, a necessary information generating process for information such as an image data file, and a copy medium generating process, as represented in the figure.

In the master generating process, generation of content data (<1>) and recording of the content data into a master medium Mm (<2>) are performed.

In this embodiment, video content data is generated as the content data. Accordingly, in the generation of content data of <1>, video content data to be stored in a copy medium as a final product is generated by performing authoring and the like.

In addition, the content data to be recorded in the master medium is not limited to the video content data, and another type of data such as application program data can be recorded therein.

In this embodiment, the master medium Mm is a memory card medium having portability such as an SD card or a micro SD card.

The master medium Mm as such a memory card medium is formatted as a predetermined file system. In this example, the master medium Mm is formatted, for example, as an FAT32 (FAT: File Allocation Table).

Subsequently, in the necessary information generating process for information such as an image file, necessary information is generated based on the master medium Mm on which the content data is recorded (stored) as described above.

The necessary information generating process for information such as an image file is performed by using a computer IMC, which is shown in the figure, used for generating an image file.

To be more specific, in the necessary information generating process for information such as an image file, generation of an image data file (<3>) is performed. In other words, an image data file (image file) for the master medium Mm on which the content data is stored previously in <2> is generated.

Here, as is widely known, the image file represents data in which the complete content and structure of a file system are stored in one file.

In addition, in the necessary information generating process for information such as an image file, generation of a master media information file (<4>) is performed.

In other words, a master media information file is generated which includes media-unique information such as a media ID, a maker code, storage capacity information, and the like, a file system information of the master medium Mm, and a hash value, which are stored in the master medium Mm.

Here, a media ID, a maker code, storage capacity information, and the like as the media-unique information are stored in a management data area of a flash memory unit 10, to be described later, included in the master media Mm, and the computer IMC for generating an image file reads out the media-unique information that is stored in the management data area.

In addition, the hash value is used for checking the identity of an image data file, which is used by a copying apparatus 1 to be described later for a copying operation, such as damage or alteration of data of the image data file and is calculated by using a predetermined calculation technique based on the content of data of the image data file generated in <3>.

In the master medium information file generating process of <4>, a file that includes medium-unique information such as the hash value, the medium ID, the maker code, or storage capacity information and file system information of the master medium. Mm is generated as the master medium information file.

In addition, various types of information described above that are included in the master medium information file may be generated in one file or may be generated in several files.

Then, in the necessary information generating process for information such as an image file, the master media generated as described above and the image data file generated in <3> are recorded as necessary information, for example, in a predetermined medium Md such as a DVD.

According to the copying method of this embodiment, the copy medium generating process is performed by using the necessary information such as the image file recorded in the medium Md as above.

This copy medium generating process is performed by using the copying apparatus 1 that includes an information processing device 1A and a memory card reader/writer unit 1rw as shown in the figure.

At this time, the memory card reader/writer unit 1rw that is included in the copying apparatus 1 is configured such that a plurality of copy destination media Mc can be detachably attached thereto, and data writing (and data reading) can be performed for the plurality of installed copy destination media Mc in parallel. Accordingly, the production of the copy media can be efficiently performed.

Here, even the copy destination medium Mc, similarly to the master medium Mm, is configured by a memory card medium such as an SD card or a micro SD card and is formatted as a predetermined file system that is set as specifications.

In addition, even for such a copy destination medium Mc, similarly to the master medium Mm, in a management data area of a memory unit (the flash memory unit 10) thereof, media-unique information such as information of a medium ID, a maker code, and a memory capacity is assumed to be stored in advance.

In the copy medium generating process, first, necessary information such as an image file or the like is fetched (<6>). In other words, the information processing device 1A included inside the copying apparatus 1 reads out the necessary information such as the image file or the like recorded on the medium Md, which is acquired in <5> described above, and stores the necessary information in an internal high-speed storage device such as an SSD (Solid State Drive).

Furthermore, the contents stored on the master medium Mm is copied to the copy destination medium Mc based on the necessary information such as the image file or the like acquired as above (<7>).

A copying method (copy media producing technique) according to this embodiment has an aspect in which the contents stored on the master medium Mm are copied to the copy destination medium Mc based on the necessary information such as the image file as above, and the detailed content will be described again later.

### 2. Internal Configuration of Each Unit

### [2-1. Internal Configuration of Memory Medium]

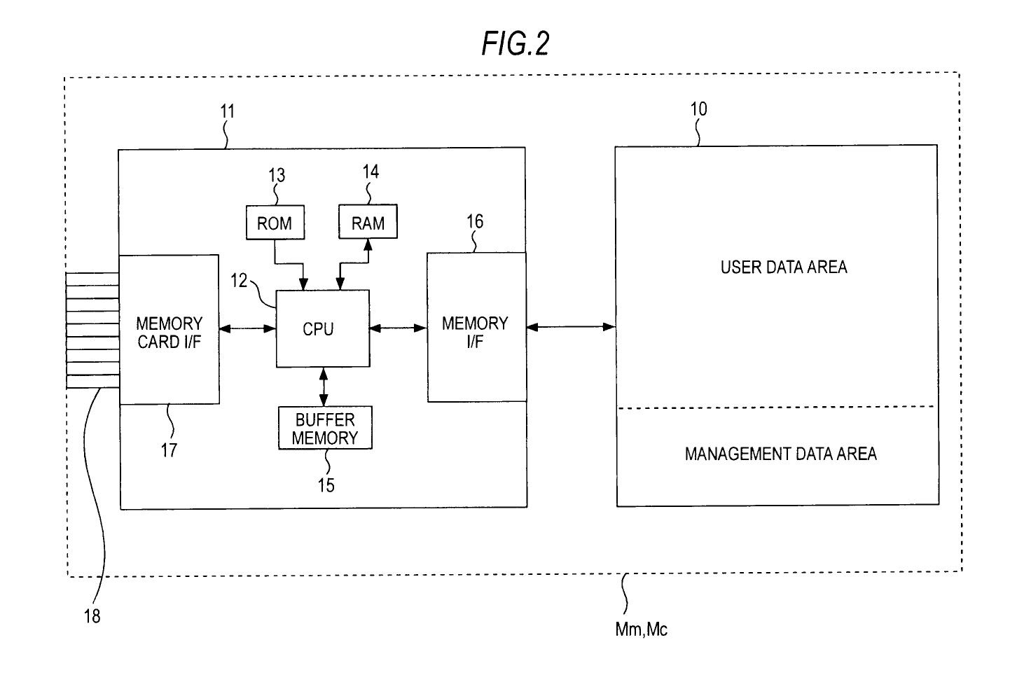

FIG. 2 represents an example of the internal configuration of a memory medium that is used in this embodiment. To be more specific, FIG. 2 illustrates the internal configuration of a master medium Mm and the copy destination medium Mc.

The master medium Mm and the copy destination medium Mc include a flash memory unit 10, a controller 11, and a terminal portion 18.

The flash memory unit 10 is configured by a non-volatile memory, and various types of data are written or read out by the controller 11 therein or therefrom.

In this flash memory unit 10, as memory areas, a user data area which user data such as the above-described video content data is written into or read out from and, similarly, a management data area in which information of a media ID, a maker code, a memory capacity, and the like is stored in advance as the above-described medium-unique information are formed.

The controller 11, as shown in the figure, includes a CPU (Central Processing Unit) 12, a ROM (Read Only Memory) 13, a RAM (Random Access Memory) 14, a buffer memory 15, a memory interface (I/F) 16, and a memory card interface 17.

The CPU 12 is connected to the units including the ROM 13, the RAM 14, the buffer memory 15, the memory interface 16, and the memory card interface 17.

When the memory card as the master medium Mm or the copy destination medium Mc is supplied with power, the CPU 12 performs overall control of the memory card by loading firmware (a program) stored in the ROM 13 into the RAM 14 and performing a process according to the firmware.

For example, the CPU 12 writes or reads out data into or from a predetermined address of the flash memory unit 10 in accordance with a write command or a read-out command transmitted from the side of a host device (corresponding to the computer IMC for generating an image file or an information processing device 1A in this example) or performs a data transmission process through the buffer memory 15, or the like.

The memory interface 16 performs a process of interfacing between the CPU 12 and the flash memory unit 10.

In addition, the terminal portion 18 is connected to the memory card interface 17 as shown in the figure, and the memory card interface 17 performs a process of interfacing between the side of a device that is communicably connected thereto through the terminal portion 18 and the CPU 12.

### [2-2. Internal Configuration of Computer for Generating Image File]

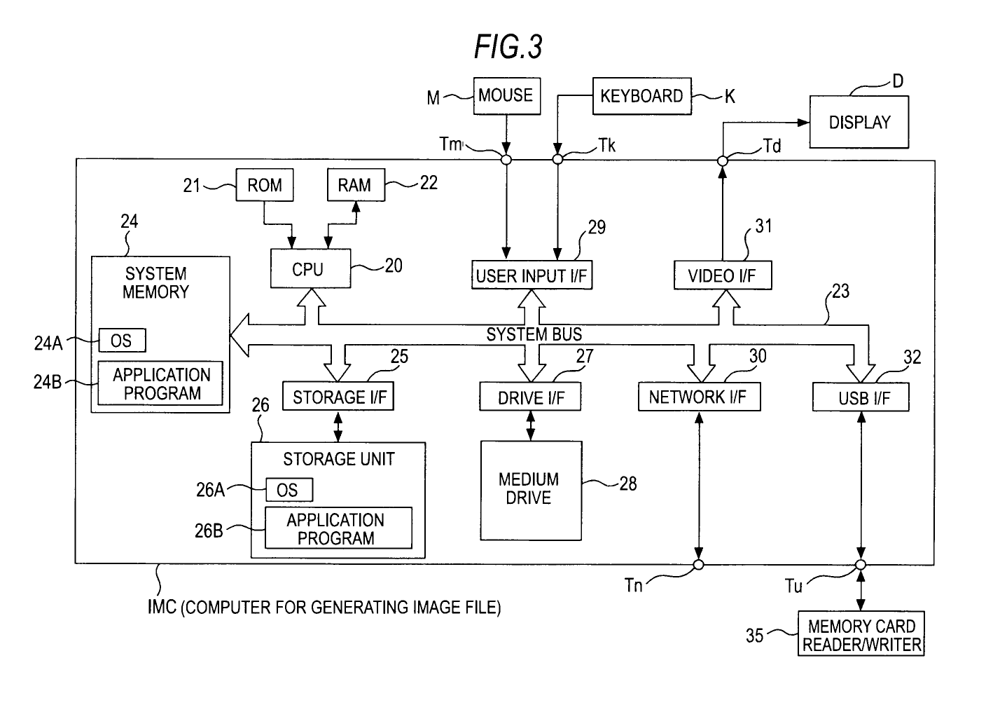

FIG. 3 illustrates the internal configuration of a computer IMC for generating an image file.

The computer IMC for generating an image file includes a CPU 20, a ROM 21, a RAM 22, a system bus 23, a system memory 24, a storage interface 25, a storage unit 26, a drive interface 27, a medium drive 28, a user input interface 29, a network interface 30, a video interface 31, and a USB (Universal Serial Bus) interface 32.

In addition, the computer IMC for generating an image file includes a mouse terminal Tm, a keyboard terminal Tk, a display terminal Td, a network terminal Tn, and a USB terminal Tu as various terminal portions.

The CPU 20 includes the ROM 21 and the RAM 22 and is communicably connected to the units including the system memory 24, the storage interface 25, the drive interface 27, the user input interface 29, the network interface 30, the video interface 31, and the USB interface 32 through the system bus 23.

The CPU 20 performs overall control of the computer IMC for generating an image file by performing a process operation in accordance with a program as an operating system 26A (hereinafter, it may be abbreviated as an OS) or an application program 26B that is stored in the storage unit 26.

Here, the storage unit 26 is configured by a storage device such as an HDD (Hard Disk Drive) or an SSD. The storage unit 26 is connected to the system bus 23 through the storage interface 25, and accordingly, the CPU 20 can instruct that various types of data are written into the storage unit 26, or data stored in the storage unit 26 is read out.

In the figure, a state is illustrated in which the operating system 26A stored in the storage unit 26 is expanded as an operating system 24A in the system memory 24. This indicates that the OS is in the middle of its operation.

In addition, similarly, the application program 26B stored in the storage unit 26 is expanded as an application program 24B in the system memory 24 and a state is illustrated in which the application program 26B is in the middle of its operation.

The system memory 24, for example, is configured by a RAM.

The medium drive 28 is configured as a drive device for a removable medium such as an optical disc recording medium, for example, a DVD or the like, a magneto optical disc recording medium, or the like.

In this embodiment, the medium drive 28 is configured so as to record or reproduce data for a DVD in correspondence with the DVD used as the above-described medium Md.

The medium drive 28 is connected to the system bus 23 through the drive interface 27. Accordingly, the CPU 20 can instruct that data is recorded into or reproduced from a removable medium that is loaded in the medium drive 28.

To the user input interface 29, as shown in the figure, a mouse M is connected through the mouse terminal Tm, and a keyboard K is connected through the keyboard terminal Tk. The user input interface 29 performs an interface process for delivering an input signal output from the mouse M or the keyboard K as input information for the CPU 20.

The CPU 20 performs a process based on the input information input from the mouse M or the keyboard K.

In addition, the network interface 30 performs an interface process for performing data communication with an external device that is connected thereto through the network terminal Tn via a network.

The video interface 31 performs an interface process for displaying video data or image data, which is supplied through the system bus 23, on a display D that is connected thereto through the display terminal Td.

The USB interface 32 performs an interface process for performing data communication between a USB device, which is connected through the USB terminal Tu, and the CPU 20.

In this example, a memory card reader/writer 35 is connected to the USB terminal Tu, and the CPU 20 transmits or receives various commands to or from the memory card reader/writer 35 or performs data communication with the memory card reader/writer 35 through the USB interface 32.

Here, the memory card reader/writer 35 is a reader/writer corresponding to the specifications of the memory card as the above-described master medium Mm. The memory card reader/writer 35 is used when the computer IMC for generating an image file generates an image data file based on the data stored in the master media Mm as described above.

In other words, the computer IMC for generating an image file generates an image data file for the master medium Mm based on the data read out from the master medium Mm that is loaded in the memory card reader/writer 35.

The process of generating an image data file for the master medium Mm as above or the above-described process of generating a master medium information file are realized through an “extraction application” represented as an application program 26B (24B) in the figure, and the contents of the process of generating an image data file and the process of generating a master medium information file, which are realized through the extraction application, will be described later in detail.

[2-3. Internal Configuration of Writing/Reading Unit Included in Copying Apparatus according to Embodiment]

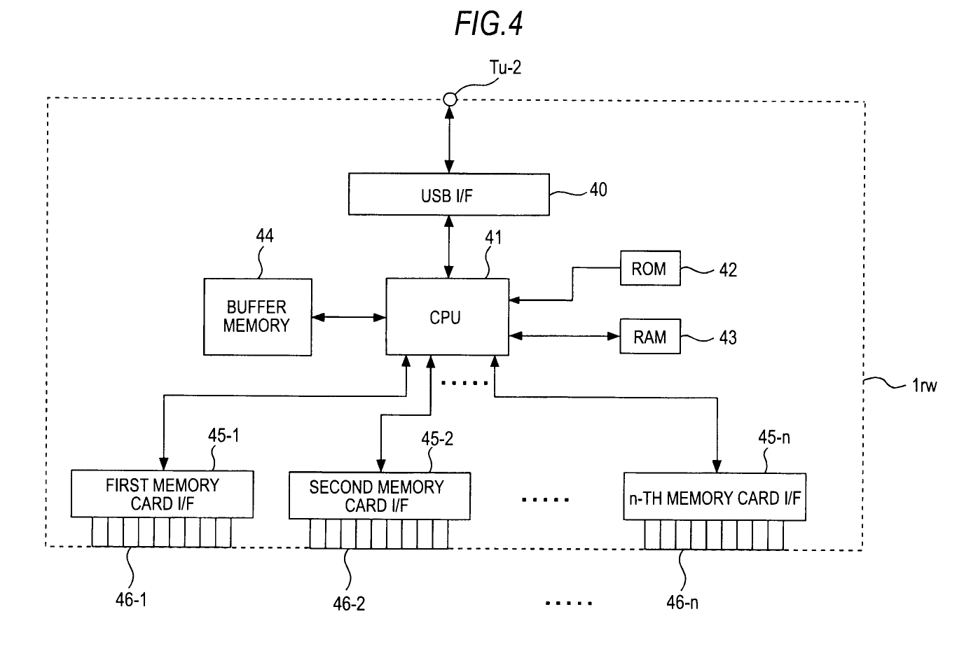

FIG. 4 represents an example of the internal configuration of a memory card writer/reader unit 1rw that is included in a copying apparatus 1 according to an embodiment.

The memory card reader/writer unit 1rw includes a USB terminal Tu-2 to be connected to a USB terminal Tu-1 to be described later through a USB cable, which is included in the information processing device 1A included inside the copying apparatus 1, and a USB interface 40 that is connected to the USB terminal Tu-2.

In addition, in the memory card reader/writer unit 1rw, a CPU 41, a ROM 42, a RAM 43, and a buffer memory 44 are included, and n memory card interfaces 45 including a first memory card interface 45-1 to an n-th memory card interface 45-n are included. As shown in the figure, in the first memory card interface 45-1, the second memory card interface 45-2, the n-th memory card interface 4-n, a first terminal portion 46-1, a second terminal portion 46-2, an n-th terminal portion 46-n are disposed. For clarification, the terminal portions 46 are to be connected to the terminal portion 18 of the memory card as the copy destination medium Mc.

As shown in the figure, the CPU 41 is connected to the ROM 42, the RAM 43, the buffer memory 44, the USB interface 40, and each memory card interface 45.

The USB interface 40 performs a process of interfacing between a control unit of an external device (in this case, the CPU 50 included in the information processing device 1A) connected through the USB terminal Tu-2 and the CPU 41.

In addition, each memory card interface 45 performs a process of interfacing between the CPU 41 and the copy destination medium Mc (CPU 12) connected through the terminal portion 46.

The CPU 41 performs overall control of the memory card reader/writer unit 1rw by performing a process according to the firmware that is stored in the ROM 42.

For example, in a case where a write command or a read-out command for a copy destination medium Mc is received from the host device side (the information processing device 1A side), the CPU 41 performs a process of transmitting the command to the copy destination medium Mc. In addition, in a case where write data for a copy destination medium Mc is received from the host device side, the CPU 41 performs a process of transmitting the data to the corresponding copy destination medium Mc. Furthermore, in a case where read data corresponding to the read-out command is received from the copy destination medium Mc, the CPU 41 performs a process of transmitting the data to the host device side.

At this time, the RAM 43 is used as a work area or the like of the CPU 41.

In addition, the buffer memory 44 is used for temporarily maintaining the transmission data.

[2-4. Internal Configuration of Control Unit Included in Copying Apparatus according to Embodiment]

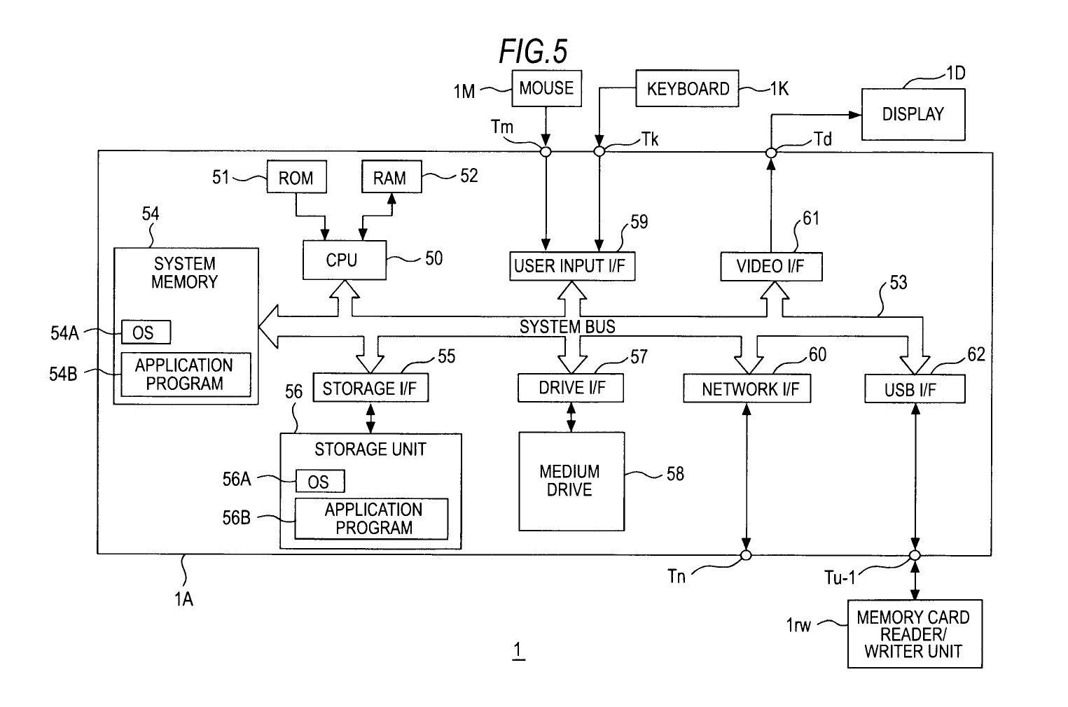

FIG. 5 is a diagram representing the internal configuration of the information processing device 1A that is included in the copying apparatus 1.

As shown in FIG. 5, inside the information processing device 1A, a CPU 50, a ROM 51, a RAM 52, a system bus 53, a system memory 54, a storage interface 55, a storage unit 56, a drive interface 57, a medium drive 58, a user input interface 59, a network interface 60, a video interface 61, and a USB interface 62 are included.

In addition, similarly to the computer IMC for generating an image file, the information processing device 1A includes a mouse terminal Tm, a keyboard terminal Tk, a display terminal Td, and a network terminal Tn as various terminal portions. In addition, a USB terminal Tu-1 is further included therein.

The CPU 50 includes a ROM 51 and a RAM 52 and is communicably connected to the units including the system memory 54, the storage interface 55, the drive interface 57, the user input interface 59, the network interface 60, the video interface 61, and the USB interface 62 through the system bus 53.

The CPU 50 performs overall control of the information processing device 1A by performing a process operation in accordance with a program as an operating system 56A or an application program 56B that is stored in the storage unit 56.

Here, the storage unit 56 is configured by a high-speed storage device such as an SSD.

The storage unit 56 is connected to the system bus 53 through the storage interface 55, and accordingly, the CPU 50 can instruct that various types of data are written into the storage unit 56, or data stored in the storage unit 56 is read out.

Here also in this case, similarly to the case illustrated in FIG. 3, a state is illustrated in which the operating system 56A stored in the storage unit 56 is expanded as an operating system 54A in the system memory 54, and the OS is in the middle of its operation.

In addition, similarly, the application program 56B stored in the storage unit 56 is expanded as an application program 54B in the system memory 54 and a state is illustrated in which the application program 56B is in the middle of its operation.

Furthermore, similarly to the system memory 24 described above, the system memory 54, for example, is configured by a RAM.

The medium drive 58 is configured as a drive device for a removable medium such as an optical disc recording medium, for example, a DVD or the like, a magneto optical disc recording medium, or the like.

In this example, similarly to the medium drive 28 described above, the medium drive 58 is configured so as to record or reproduce data for a DVD in correspondence with the DVD used as the above-described medium Md.

The medium drive 58 is connected to the system bus 53 through the drive interface 57. Accordingly, the CPU 50 can instruct that data is recorded into or reproduced from a removable medium that is loaded in the medium drive 58.

To the user input interface 59, a mouse 1M is connected through the mouse terminal Tm, and a keyboard 1K is connected through the keyboard terminal Tk. The user input interface 59 performs an interface process for delivering an input signal output from the mouse 1M or the keyboard 1K as input information for the CPU 50.

The CPU 50 performs a process based on the input information input from the mouse 1M or the keyboard 1K.

In addition, the network interface 60 performs an interface process for performing data communication with an external device that is connected thereto through the network terminal Tn via a network.

The video interface 61 performs an interface process for displaying video data or image data, which is supplied through the system bus 53, on a display 1D that is connected thereto through the display terminal Td.

The USB interface 62 performs a process of interfacing between a USB device (particularly, the memory card reader/writer unit 1rw shown in FIG. 4 in this case) connected through the USB terminal Tu-1 and the CPU 50.

Here, the information processing device 1A (CPU 50) is configured so as to perform various operations according to an embodiment to be described below by using an “copy application” represented as an application program 56B (54B) in the figure. The detailed process flow that is performed by the CPU 50 in accordance with the application program 56B (54B) as the copy application for realizing the operation according to the embodiment will be described later.

### 3. Copying Method according to Embodiment

As can be understood from the description hitherto, according to this embodiment, an image data file for the master medium Mm is generated, and the image data file is fetched by the copying apparatus 1.

Here, according to a general method described as above in 3), the image data file that is fetched by the copying apparatus as above is directly copied to a medium as a copy destination, thereby performing the copying process at high speed.

However, according to the general technique described in 3), there is a problem in that it is difficult to appropriate perform the copying process in a case where the memory capacities of the master medium and the copy destination medium are different from each other by only one byte.

In view of such a problem, according to this embodiment, the image data file is not directly copied in a simple manner, but a technique is used in which data included in the image data file is copied in units of files and folders for a medium having a memory capacity different from that of the master medium.

In other words, to be more specific, a file/folder recognizing process is performed for an image data file fetched by the copying apparatus 1 (the information processing device 1A) such that data included in the image data file can be recognized in units of files and folders by the OS. Then, for a copy destination medium Mc having a memory capacity that is different from that of the master medium, data copy is performed in unit of the files and the folders that are recognized as above.

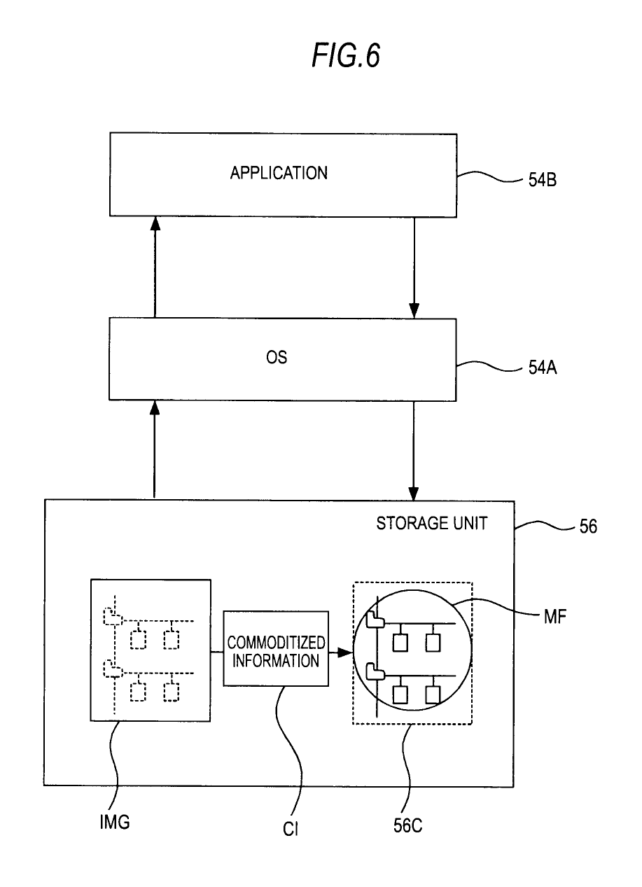

FIG. 6 is a diagram illustrating a file/folder recognizing process for an image data file.

In this figure, an application program 54B, an operating system 54A, and a storage unit 56 are illustrated. As illustrated in FIG. 6, the application program 54B can be represented so as to operate on the operation system 54A.

In the description presented below, an image data file (in this case, it is fetched through the medium Md shown in FIG. 1) that is fetched by the information processing device 1A is represented by an image data file IMG.

First, in the figure, while the directory structure within the image data file IMG (the directory structure of the master medium Mm) is represented by using a symbol representing a folder and a symbol representing a file (a rectangular shape), the reason for denoting the directory structure by a broken line is so as to represent that it is difficult for the operating system 54A to recognize the internal data in units of files and folders in the image data file IMG state.

As above, it is difficult for the operating system 54A to recognize the internal data in units of files and folders in the state of the image data file IMG. Accordingly, as a file/folder recognizing process, a process is performed in which the data included in the image data file IMG is recognized so as to be able to be handled by the operating system 54A in units of files and folders.

As a concrete technique used for the file/folder recognizing process, there is a technique in which commoditized information CI allowing the OS 54A to recognize data included in the image data file IMG in units of files and folders is generated based on the file system information by referring to file system information included in the image data file IMG. In other words, in this case, the OS 54A can handle the files and folders within the image data file IMG as files and folders that are present in a virtual area 56C as in the figure by referring to the commoditized information IC.

The files and folders within the image data file IMG that can be handled as being present in the virtual area 56C through the file/folder recognizing process as above (that is, files and folders that can be regarded as being commoditized with the image data file IMG) are configured as files and folders within the master.

Alternatively, the file/folder recognizing process may be configured as a mount process that is generally performed. In other words, the image data file IMG is recognized by the OS 54A as forming one volume through a virtual driver.

In this case, information used for realizing the virtual driver corresponds to the commoditized information CI.

For clarification, the above-described file/folder recognizing process is performed by the operating system 54A in accordance with application program 54B.

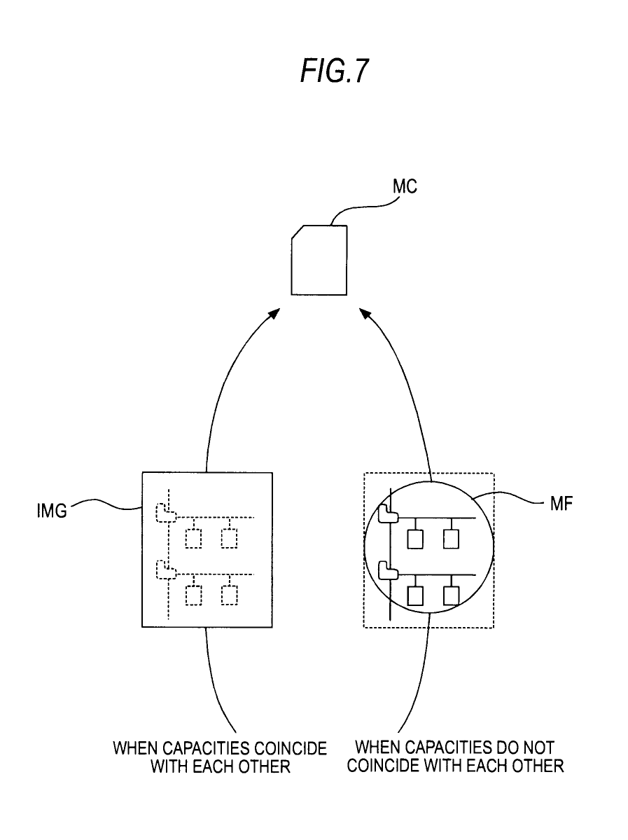

FIG. 7 is a diagram illustrating a writing control technique according to an embodiment.

By performing the file/folder recognizing process as described above, a state is formed within the copying apparatus 1 (the information processing device 1A) in which the image data file IMG for the master medium Mm and the files and folders MF within the master are regarded as being present together.

The copying apparatus 1 according to this embodiment selects whether the image data file IMG is copied or the files and folders MF within the master are copied (data within the image data file IMG is copied in units of files and folders) based on a result of comparison of the memory capacity information of the copy destination medium Mc and the memory capacity information of the master medium Mm.

To be more specific, the memory capacity information is read out from the copy destination medium Mc installed to the memory card reader/writer unit 1rw, and the memory capacity information of the master medium Mm is acquired from the inside of the master medium information file described above, and the memory capacities are compared with each other. Then, for a copy destination medium Mc having a memory capacity coinciding with that of the master medium Mm, the image data file IMG is copied. On the other hand, for a copy destination medium Mc having a memory capacity not coinciding with that of the master medium Mm, the files and folders MF within the master are copied.

By allowing the data within the image data file IMG so as to be copied in units of folders and files as above in a case where the memory capacities do not coincide with each other, unlike a general technique 3) in which the image data file IMG is directly copied to a medium having a memory capacity not coinciding with that of the master medium, a problem such as a medium which, after the copying process, violates the specifications does not occur. As a result, even for a copy destination medium Mc having a memory capacity different from that of the master medium Mm, an appropriate copying process can be performed.

In addition, according to the writing control (copying technique) of this embodiment, in a case where the memory capacity of the copy destination medium Mc is larger than that of the content data to be copied, an appropriate copying process can be performed even for a copy destination medium Mc having any memory capacity.

Here, a case may be considered in which the memory capacity of the copy destination medium Mc is smaller than that of the content data (the content data stored in the master medium Mm) to be copied.

In such a case, it is difficult to physically completely copy the content data to the copy destination medium Mc. Thus, in this case, the copying process for the copy destination medium Mc is stopped.

However, according to the copying technique of this embodiment described as above, the files and folders MF within the master, which are recognized by the operating system 54A through the file/folder recognizing process in the information processing device 1A, is in the state of being maintained in the information processing device 1A, for example, during a necessary period such as a period until completion of the production of the copy medium.

During the period in which the files and the folders MF within the master are maintained, it can be stated that there is little possibility of the occurrence of destruction or alteration of data of the files and folders MF within the master due to virus infection or the like.

Thus, according to this embodiment, a process of allowing the files and the folders MF within the master to be recognized by the operating system 54A as Read-Only files and folders (that are readable only) is performed as the above-described file/folder recognizing process.

Accordingly, the data of the files and the folders MF within the master, which are maintained in the information processing device 1A, can be prevented from being destructed or altered due to virus infection or the like.

In addition, in this embodiment, a process of checking whether the data of the image data file IMG fetched by the information processing device 1A is damaged or altered using the hash value that is stored in the master medium information file described above is also performed.

To be more specific, a hash value is calculated for the image data file IMG by using the same technique as that of the “predetermined calculation technique” described above (the calculation technique that is used for calculating a hash value stored in the master medium information file by the computer IMC for generating an image file), and it is checked whether or not the calculated hash value coincides with the hash value stored in the master medium information file.

To be yet more specific, it is determined whether both the hash values coincide with each other. In a case where both the hash values coincide with each other, the file/folder recognizing process and the writing control process described above are performed. On the other hand, in a case where both the hash values do not coincide with each other, as an error process, a process for a request to re-fetch the image data file IMG from the medium Md is performed. For example, as this error process, a process of displaying a message indicating an error in the image data file IMG on the display 1D is performed.

Accordingly, a defective product can be effectively prevented from being manufactured.

### 4. Processing Flow

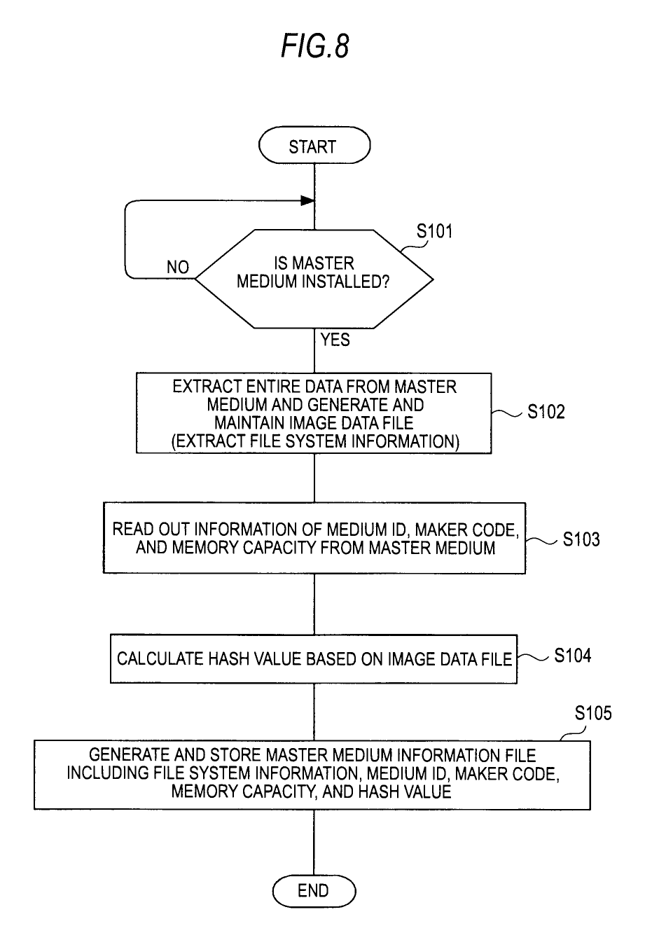

Subsequently, a detailed processing flow to be performed so as to realize the copying technique according to the above-described embodiment will be described with reference to the flowcharts shown in FIGS. 8 to 10.

FIG. 8 illustrates a detailed flow of the process to be performed in the computer IMC for generating an image file when necessary information such as an image data file of a master medium is generated.

The process illustrated in FIG. 8 is performed by the CPU 20 shown in FIG. 3 as the “extraction application” represented by the application program 26B (24B).

As shown in FIG. 8, in Step S101, the process waits until a master medium Mm is loaded. In other words, a process of determining whether or not the master medium Mm is loaded is performed until a positive result is acquired.

To be more specific, in this Step S101, it is determined whether or not a master medium Mm is load to the memory card reader/writer 35 that is connected through the USB terminal Tu shown in FIG. 3.

Then, in a case where the master medium Mm is loaded and a positive result is acquired, the process proceeds to Step S102.

In Step S102, all the data is extracted from the master medium Mm, and a process of generating and storing an image data file is performed.

In other words, all the data that is stored in the master medium Mm (user data area) is read out by the memory card reader/writer 35 through the USB interface 32, an image data file for the master medium Mm is generated based on the data read out by the memory card reader/writer 35, and the image data file is stored in a necessary memory device such as a storage unit 26.

At this time, file system information of the master medium Mm is included in the data readout from the master medium Mm. In order to include the file system information in a master medium information file that is generated in Step S105 to be described later, the file system information is extracted in Step S102 and is stored (temporarily maintained) in a necessary memory device such as the system memory 24.

Subsequently, in Step S103, a process of reading out a medium ID, information of a maker code, and memory capacity from the master medium is performed.

In other words, the information of the medium ID, the maker code, and the memory capacity, which is stored in the management data area of the master medium Mm, is read out by the memory card reader/writer 35, and each type of information read out by the memory card reader/writer 35 is temporarily stored, for example, in the system memory 24.

Next, in Step S104, a hash value is calculated based on the image data file.

After the hash value is calculated, in Step S105, a process of generating and storing a master medium information file that includes file system information, the medium ID, the maker code, the memory capacity, and the hash value is performed.

In other words, the master medium information file that includes the file system information of the master medium Mm that is temporarily maintained in Step S102 performed in advance, the information of the medium ID, the maker code, and the memory capacity that is temporarily maintained in Step S103, and the information of the hash value that is calculated in Step S104 is generated and is stored, for example, in the storage unit 26.

In Step S105 described above, the process performed by the “extraction application” illustrated in this figure ends.

Here, according to the description presented above with reference to FIG. 1, while the image data file and the master medium information file generated as described above are copied to the medium Md, the process of copying the image data file and the master medium information file to the medium Md is performed by the computer IMC for generating an image file, for example, as performed by an operator or anyone else operating the mouse M or the like. To be more specific, there is a technique of writing the image data file and the master medium information file on the medium Md, for example, by using a writing function or the like that is included in the operating system 26A (24A) in accordance with the operation of the mouse M or the like that is performed by the operator or anyone else in the state in which the medium Md is loaded into the medium drive 28.

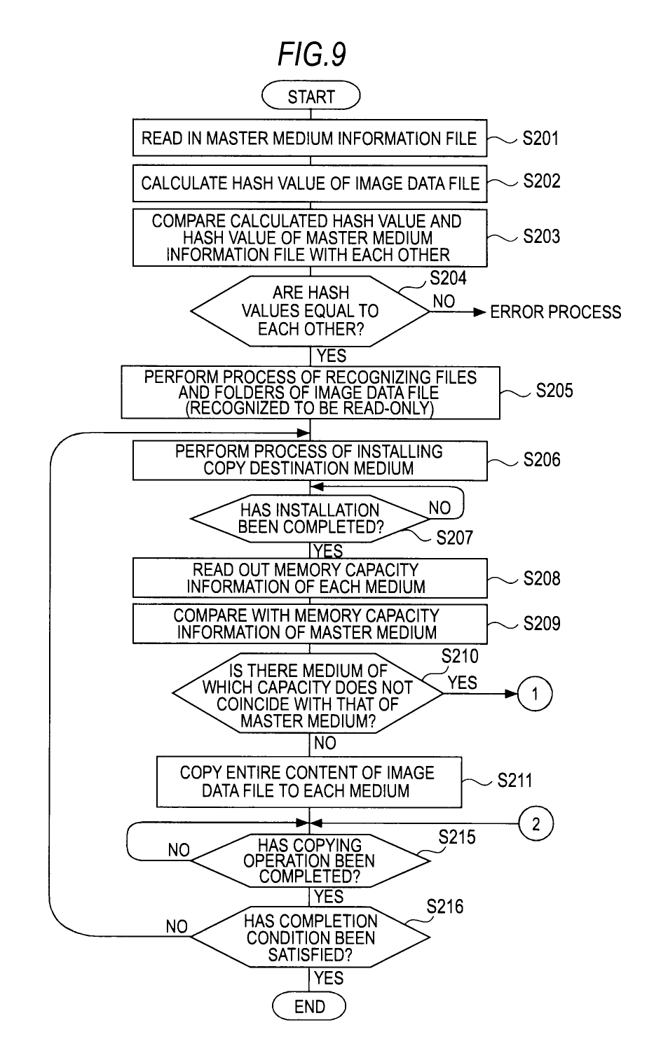

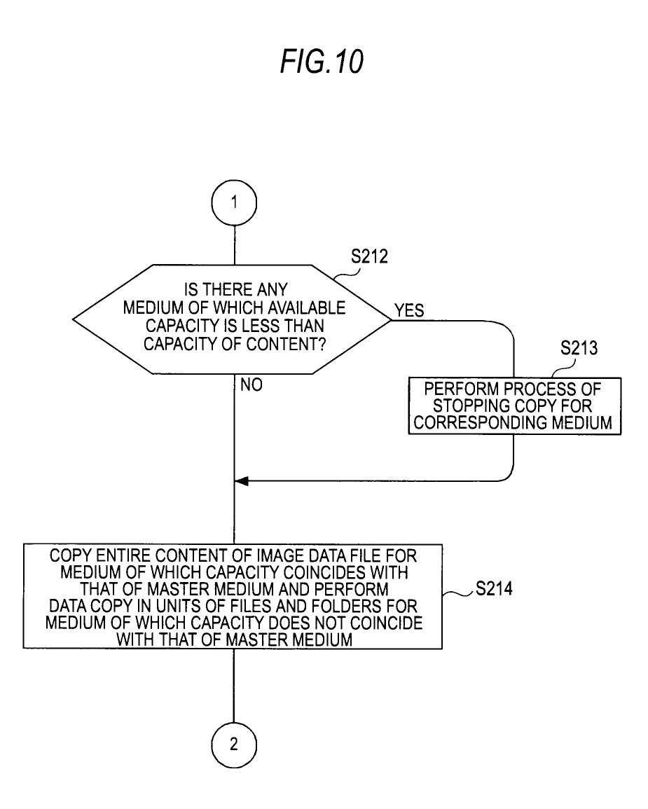

FIGS. 9 and 10 illustrate a detailed flow of the process to be performed by the copying apparatus 1 (information processing device 1A) according to an embodiment when data is copied to the copy destination medium Mc.

The process illustrated in FIGS. 9 and 10 is performed by the CPU 50 shown in FIG. 5 as a process performed through a “copying application” that is represented by the application program 56B (54B).

In addition, when the process illustrated in FIGS. 9 and 10 is performed, it is assumed that the fetching of the image data file and the master medium information file from the medium Md is completed in the information processing device 1A. In the fetching of the image data file and the master medium information file into the information processing device 1A is performed by the information processing device 1A, for example, in accordance with the operation of the mouse 1M or the like that is performed by an operator or anyone else. As can be understood by referring to FIG. 6, the reading out of the image data file (IMG) in this case is performed for the storage unit 56. In addition, the master medium information file, for example, is assumed to be fetched in the storage unit 56.

First, as illustrated in FIG. 9, in Step S201, a process of reading the master medium information file is performed. In other words, for example, as described above, a process of reading out the master medium information file fetched (stored) in the storage unit 56 and maintaining the master medium information file in the system memory 54 is performed.

Then, in the following Step S202, the hash value of the image data file IMG is calculated. In other words, the hash value for the image data file IMG that is stored in the storage unit 56 is calculated by using the same calculation technique as the above-described predetermined calculation method.

Next, in Step S203, the calculated hash value and the hash value of the master medium information file are compared with each other.

Then, in Step S204, it is determined whether the hash values are the same.

In a case where the hash values are determined not to be the same and a negative result is acquired in Step S204, as illustrated in the figure, an error process is performed. As described above, as the error process, for example, a process of displaying a message that indicates an error in the image data file IMG on the display 1D is performed.

On the other hand, in a case where the hash values are determined to be the same and a positive result is acquired in Step S204, the process proceeds to Step S205, and a file/folder recognizing process for the image data file IMG is performed.

In other words, as described above, the process of allowing the data included in the image data file IMG to be recognized is performed such that the operating system 54A can handle the data in units of files and folders.

As described above, the file/folder recognizing process in the case of this example is performed such that the files and the folders MF recognized through the file/folder recognizing process are recognized by the operating system 54A as Read-Only files and folders.

In the following Step S206, a process of loading a copy destination medium Mc is performed.

For example, in a case where the loading of each copy destination medium Mc into the memory card reader/writer unit 1rw is configured so as to be automatically performed not by using the hands of an operator but by using a necessary power mechanism, the loading process of Step S206 is a process of instructing the control unit controlling the power mechanism to load each copy destination medium Mc.

On the other hand, in case where the loading is configured to be manually performed by an operator, the loading process is, for example, a process of displaying a message that is used for requesting to load the copy destination medium Mc on the display 1D.

After the loading process of Step S206 is performed, in Step S207, the process waits until the loading is completed.

In other words, the process waits until the copy destination media Mc (the terminal portions 18) are in the state (that is, a communicably connected state) of being connected to all the terminal portions 46 of the memory card reader/writer unit 1rw.

In a case where the loading of the copy destination media Mc is completed, and a positive result is acquired in Step S207, a process of reading the memory capacity information of each medium is performed in Step S208.

In other words, the memory card reader/writer unit 1rw is instructed so as to read out the memory capacity information from each copy destination medium Mc, and the memory capacity information read out from each copy destination medium Mc in accordance with the instruction, for example, is temporally stored in the system memory 54.

In the following Step S209, comparison with the memory capacity information of the master medium is performed. In other words, the memory capacity information of each copy destination medium Mc read out in Step S208 and the memory capacity information of the master medium Mm that is stored in the master medium information file temporarily maintained in advance in Step S201 are compared with each other.

Then, next, in Step S210, it is determined whether there is a medium of which the capacity does not coincide with that of the master medium.

In a case where there is no medium of which the capacity does not coincide with that of the master medium, and a negative result is acquired in Step S210, the process proceeds to Step S211, and a process of copying the entire content of the image data file IMG to each medium is performed. In other words, a process of writing the entire content of the image data file IMG into all the loaded copy destination media Mc is performed by the memory card reader/writer unit 1rw.

Next, in Step S215, the process waits until the copying process is completed.

Then, in a case where the copy is completed and a positive result is acquired, it is determined whether a completion condition is satisfied in Step S216. In other words, it is determined whether or not a predetermined completion condition set in advance such as the completion of copying data to copy destination media Mc corresponding to the production number set in advance or supply of a completion instruction signal from the outside.

In a case where the completion condition is not satisfied, and a negative result is acquired in Step S216, the process is returned back to the loading process of Step S206. Accordingly, a copying operation for a new copy destination medium Mc is repeated until the completion condition is satisfied.

On the other hand, in a case where there is a medium of which the capacity does not coincide with that of the master medium, and a positive result is acquired in Step S210, the process proceeds to Step S212 illustrated in FIG. 10.

As represented in FIG. 10, in Step S212, it is determined whether there is a medium of which the available capacity is smaller than the capacity of the content.

Here, the data capacity of the content can be specified based on the file system information of the master medium Mm that is stored in the master medium information file. In addition, the available capacity represents the available memory capacity of the user data area for each copy destination medium Mc.

In Step S212, it is determined whether or not there is a copy destination medium Mc of which the available data capacity is smaller than the data capacity of the content that is specified as above.

In Step S212, in a case where there is a copy destination medium Mc of which the available capacity is smaller than the capacity of the content, and a positive result is acquired, the process proceeds to Step S213, and a copy stopping process for the medium is performed.

This copy stopping process is not particularly limited as long as it is a process of stopping copying data to the copy destination medium Mc. As an example, there is a process in which the copy destination medium Mc is disengaged (software disengagement of cancelling the communicable connection state or, in a case where the loading of the copy destination medium Mc is configured so as to be automatically performed as described above or instructing the above-described control unit to physically disengage the copy destination medium Mc), and a message indicating the stopping copying data to the copy destination medium Mc is displayed on the display 1D.

After the copy stopping process is performed in Step S213, the process proceeds to Step S214.

On the other hand, in Step S212 described above, even in a case where there is no medium of which the available capacity is smaller than the capacity of the content, and a negative result is acquired, the process proceeds to Step S214.

In Step S214, the entire content of the image data file IMG is copied to all the media of which the capacity coincides with that of the master medium, and data copy is performed in units of files and folders for the medium of which the capacity does not coincide with that of the master medium.

In other words, for the copy destination medium Mc of which the memory capacity coincides with that of the master medium Mm, similarly to Step S211 previously performed, a process of copying the entire content within the image data file IMG is performed.

On the other hand, for the copy destination medium Mc of which the memory capacity is determined not to coincide with that of the master medium Mm, a process of writing the files and folders MF within the master, which has been described above, is performed. In other words, in Step S205, the data of the image data file IMG is copied in units of files and folders recognized by the operating system 54A.

In addition, for clarification of the description, although file system information is written into the corresponding copy destination medium Mc when the process of writing data of the image data file IMG in units of files and folders is performed, generally, the function of generating and writing the file system information is included on the OS side but is not performed on the application side.

After the copying process of Step S214 is performed, the process proceeds to Step S215 illustrated in FIG. 9, and the process waits until the completion of the copy. Then, after the completion of the copy, it is determined whether or not the completion condition is satisfied in Step S216. As described above, in a case where the completion condition is not satisfied in Step S216, and a negative result is acquired, the process is returned back to the loading process of Step S206.

On the other hand, in a case where the completion condition is satisfied in Step S216, and a positive result is acquired, the process performed by the “copying application” illustrated in FIGS. 9 and 10 is completed.

In addition, in the processing flow of FIGS. 8 to 10 described as above, the order of each process may be changed as long as there is no problem in changing the order of the process.

For example, as illustrated in FIG. 8, the order of the processes of Steps S103 and S104 may be changed. In addition, as illustrated in FIG. 9, although the copy destination medium Mc is loaded after the coincidence of the hash values is checked, the order thereof may be reversed.

As illustrated in FIG. 9, in accordance with the waiting process of Step S207, the process for copying data to the copy destination media Mc is performed in a case where the copy destination media Mc are installed to all the terminal portions 46. However, a case where copying is desirably performed without connecting the copy destination media Mc to some of the terminal portions 46, for example, depending on the production number of the products may be considered.

For example, in consideration of such a case, the process may be changed so as to proceed to the process for copying data of Step S208 and after that in the order of the copy destination medium Mc of which installation is checked first.

Alternatively, the waiting process of Step S207 may be changed to a process of waiting until either a condition of installation of the copy destination media Mc to all the terminal portions 46 or a condition of the elapse of a predetermined time after the loading process of Step S206 is satisfied, so that the process can proceed to the next step even in a case where the copy destination media Mc are not installed to all the terminal portions 46.

### 5. Statistics of Embodiments

According to the above-described copying technique (copy medium producing technique) according to the embodiment, even in a case where the memory capacities of the master medium Mm and the copy destination medium Mc are different from each other (excluding a case where the memory capacity is smaller than the capacity of the content data to be copied), the content stored in the master medium Mm can be appropriately copied to the copy destination medium Mc.

In addition, simultaneously, according to the above-described copying technique of this embodiment, unlike the general technology 2), the copy speed is not depend on the data transmission rate of the master medium or the speed of the reading device, and, from that point of view, a high sped copying operation is realized.

Furthermore, in a case where the memory capacities are the same, the image data file IMG can be directly copied to the copy destination medium Mc. Accordingly, from this point of view, the high copy speed as in the general technique described in 3) can be maintained.

In addition, according to the copying technique of this embodiment, since the data extracted from the master medium Mm is moved once to a medium Md such as a DVD, unlike the general technique disclosed in 1), data to be copied to copying apparatus is prevented from being laid in the copying apparatus for a long time. Accordingly, from this point of view, the possibility of the occurrence of data destruction or data alteration accompanied with virus infection can be lowered.

Furthermore, according to the copying technique of this embodiment, the image data file IMG is recognized as Read-Only files and folders when being recognized in units of files and folders by the OS. Accordingly, from this point of view, the occurrence of data destruction or data alteration due to virus infection can be effectively prevented.

In addition, according to the copying technique of this embodiment, since archive software, which is used in the general technique 1), is not used, the file attribute data and the date data of the file stored in the master medium Mm can be remained as they are.

On the other hand, as a countermeasure against an inappropriate copying operation in the case of different memory capacities, a technique may be considered in which a plurality of image data files IMG are prepared in correspondence with each memory capacity before the copying operation.

In other words, such a technique is a technique in which not only one image data file IMG corresponding to the memory capacity of the master medium Mm is prepared, but image data files IMG of which the memory capacities are set differently therefrom are prepared, and one corresponding to the memory capacity of the actual copy destination medium Mc is selectively copied out of the plurality of image data files IMG of which the memory capacities are set differently from each other.

However, in a case where such a technique is employed, when there are many types of the memory capacities of the copy destination medium Mc, the number of the image data files IMG to be prepared is increased as that many. Accordingly, the memory capacity of the storage unit in which the image data files are maintained is unnecessarily consumed as that much or a storage unit having a higher capacity (and higher cost) is necessarily used.

In addition, as described in the embodiment as an example, in a case where a copying process is started by the copying apparatus 1 in the state in which only the image data file IMG extracted from the master medium Mm is maintained, a copying operation for the copy destination medium Mc is not performed while the image data files IMG corresponding to various capacities are copied, and there is a problem in that time is necessary for generating the copy medium.

Particularly, there is also a case where long time is necessary for converting the image data file IMG into image data files IMG of which the capacities are differently set depending on the type of the image data file IMG. In such a case, there is a concern that the generation time of the copy medium is greatly delayed.

Furthermore, even in a case where the image data files IMG of which the capacities are differently set can be generated, there is a concern that it is difficult to perform an appropriate copying operation in a case where the file system thereof is not in correspondence with the specifications of the copy destination medium Mc.

For example, in a case where the generated image data file IMG corresponds to FAT32, and the copy destination medium Mc corresponds to exFAT, when the image data file IMG is directly copied to the copy destination medium, the file system is changed to FAT 32. Accordingly, a case may be considered in which the copy destination medium Mc is treated as a corrupted medium due to a violation of the specifications or the like, and, from this point of view, a copying operation is not appropriately performed.

In a case where the copying operation is performed in units of files and folders as in this embodiment, any capacity can be responded unless the available capacity of the copy destination medium Mc is less than the capacity of the content to be copied. Accordingly, it is not necessary to prepare the image data files IMG having different memory capacities, and the capacity of the storage unit can be suppressed to a capacity for which at least one image data file IMG can be maintained.

In addition, since the plurality of the image data files IMG are not necessarily generated, the generation time of the copy medium can be shortened.

Furthermore, even in a case where the file system of the master medium Mm and the file system of the copy destination medium Mc to be employed are different from each other, such a difference can be absorbed by the OS. Accordingly, a copying operation can be appropriately performed.

### 6. Modified Examples

Although the embodiments of the present invention have been described as above, the present invention is not limited to the concrete examples described until now.

For example, in the description presented until now, whether the copying of the image data file IMG is performed or a copying operation in units of files and folders is performed is selected depending on the memory capacity information. However, depending upon the situations, a case may be considered in which the information of the maker code (code information representing the manufacturer of the flash memory unit 10) that is stored on the medium represents a difference in the memory capacity.

In such a case, since the difference in the maker code may be regarded as a difference in the memory capacity, the above-described selection process may be performed based on a result of comparison between the maker code of the master medium Mm and the maker code readout from the copy destination medium Mc.

Alternatively, a case may be considered in which the memory capacity differs in a case where the range of the value of the medium ID is different.

In this case, since the difference in the value of the medium ID may be regarded as a difference in the memory capacity, the above-described selection may be performed based on a result of comparison between the range of the value of the medium ID of the master medium Mm and the range of the number read out from the copy destination medium Mc.

As above, in order to prevent an inappropriate copying operation for the copy destination medium Mc due to the difference between the capacities of the master medium Mm and the copy destination medium Mc, whether the copying of the image data file IMG is performed or the copying in units of files and folders is performed may be selected based on, at least, result of comparison of the medium-unique information.

In addition, in the description presented until now, a case has been described as an example in which the image data file or the master medium file that is generated by the computer IMC for generating an image file is received by the copying apparatus 1 (the information processing device 1A) through the medium Md. However, such information may be fetched by the information processing device 1A through a network.

Furthermore, in the description presented until now, the image data file read out from the medium Md and the master medium information file (the unique information of the master medium Mm) are stored in the same memory device as the storage unit 56 of the information processing device 1A. However, the image data file and the master medium information file may be stored in different memory devices.

In addition, in the description presented until now, both the files and the folders are recognized as Read-Only as the file/folder recognizing process through the Read-Only image data file. However, only the files or the folders may be recognized as Read-Only.

Alternatively, in a case where the image data file IMG is mounted as one volume by a virtual driver, the volume may be recognized as Read-Only.

In addition, in the description hitherto, a case has been described as an example in which the generating of the image data file of the master medium Mm and the copying of the copy destination medium Mc are performed by different devices. However, it is apparent that such operations can be performed by using one copying apparatus 1.

In such a case, the information processing device 1A may be configured so as to perform the process of the extraction application illustrated in FIG. 8.

In addition, although not particularly mentioned in the description presented until now, the copying process, which is performed by the copying apparatus 1, of the copy destination medium Mc may be performed in accordance with copying conditions that are set in advance.

For example, as the above-described copying conditions, whether or not the copy destination medium Mc is formatted before the copying operation, whether or not the medium type is checked, whether or not the capacity is checked, whether or not data comparison with the image data file is performed after the copying operation, or the like is set in advance, and the copying apparatus 1 performs a copying process of the copy destination medium Mc in accordance with the copying conditions.

At this time, the setting of the copying conditions may be performed by the side of the computer IMC for generating an image file or the side of the copying apparatus 1. In a case where the side of the computer IMC for generating an image file sets the copying conditions, information representing the setting conditions (setting condition information) is recorded on the medium Md, for example, together with the master medium information file or the like, and the side of the copying apparatus 1 may perform a copying process of the copy destination medium Mc in accordance with the setting condition information read out from the medium Md.

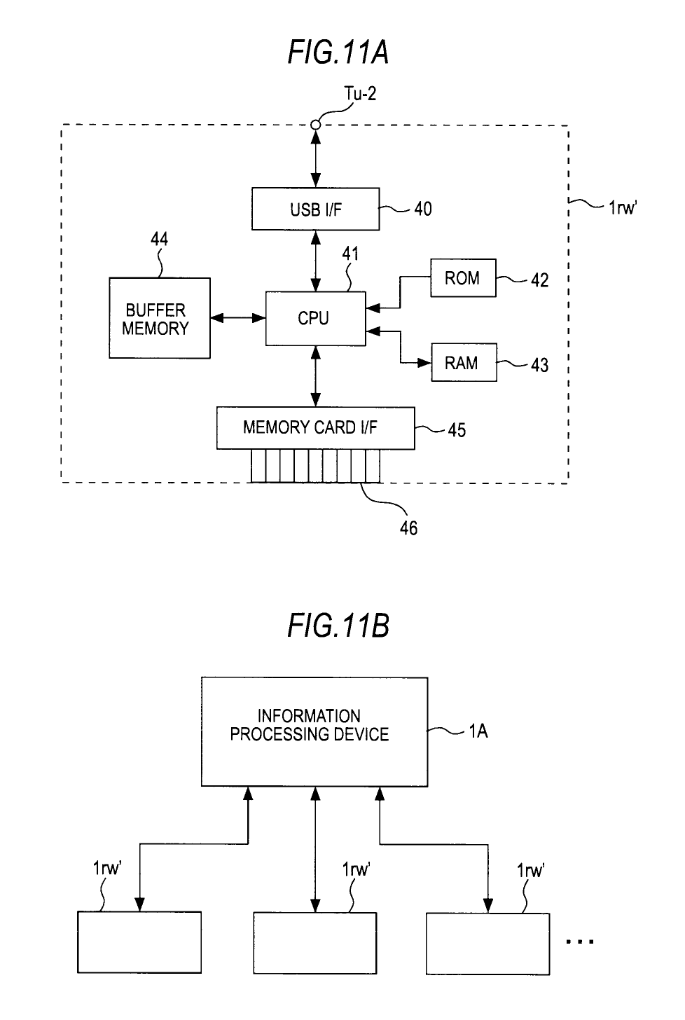

In addition, in the description presented until now, for copying data to a plurality of copy destination media Mc in parallel by using the copying apparatus 1, as illustrated above in FIG. 4, a configuration has been described as an example in which only one memory card reader/writer unit 1rw including a plurality of sets of the memory card interface 45 and the terminal portion 46 is connected to the information processing device 1A. Instead of such a configuration, for example, as illustrated in FIG. 11A, a configuration may be employed in which a plurality of racks thereof are connected to the information processing device 1A as illustrated in FIG. 11B by using a memory card reader/writer unit 1rw′ that includes only one set of the memory card interface 45 and the terminal portion 46.

Furthermore, in this case, as the memory card reader/writer unit that is connected to the information processing device 1A, the memory card reader/writer unit 1rw including a plurality of sets of the memory card interface 45 and the terminal portion 46 may be used in a mixed manner. Alternatively, a configuration may be employed in which the memory card reader/writer unit 1rw is connected to a plurality of racks.

In addition, in the description presented until now, a case has been described in which the interface, which is included in the computer IMC for generating an image file, for the memory card reader/writer 35 and the interface, which is included in the information processing device 1A, for the memory card reader/writer unit 1rw (or 1rw′) are USB interfaces. However, as such interfaces, interfaces according to other specifications such as a PC Card interface or an Express Card interface may be used, and furthermore, a configuration may be employed in which the interfaces according to other specifications are used in a mixed manner.

In the description presented until now, a case has been described as an example in which the master medium and the copy destination medium are memory card media such as SD cards or Micro SD cards. However, as the master medium and the copy destination medium, other media each including a memory device storing data therein such as a semiconductor memory device may be used.

For example, a so-called USB memory may be used. In addition, in the case where the USB memory is used, when the information processing device of the copying apparatus includes an USB interface, an additional writing/reading device such as the memory card reader/writer unit 1rw is unnecessary.

The present application contains subject matter related to that disclosed in Japanese Priority Patent Application JP 2010-148605 filed in the Japan Patent Office on Jun. 30, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A copying apparatus that is used for copying data stored in a memory medium, which includes a memory unit storing the data therein and has a management data area in which unique information of the memory medium is stored and a user data area into which user data is written, as a master medium to the memory medium as a copy destination medium, the copying apparatus comprising:
a memory means for storing an image data file of the master medium and the unique information that is stored in the management data area of the master medium therein;
a reading/writing unit that writes or reads data on or from the installed copy destination medium; and
a control unit that is configured so as to perform a necessary control process by operating an operating system based on an application program,
wherein the control unit performs a file/folder recognizing process that allows data included in the image data file, which is stored by the memory means, to be recognized so as to be able to be handled by the operating system in units of files and folders and a writing control process in which the writing/reading unit reads out the unique information stored in the management data area of the copy destination media, and image file writing control in which the image data file is controlled so as to be written on the copy destination medium or writing control in units of files and folders in which the data included in the image data file is written onto the copy destination medium in units of the files and the folders recognized by the operating system through the file/folder recognizing process is selectively performed based on a result of comparison between the read-out unique information of the copy destination medium and the unique information of the master medium that is stored in the memory means.

2. The copying apparatus according to claim 1, wherein, in the writing control process, it is determined whether or not the unique information of the copy destination medium and the unique information of the master medium coincide with each other, the image file writing control is performed in a case where the unique information of the copy destination medium and the unique information of the master medium are determined to coincide with each other, and the writing control in units of files and folders is performed in a case where the unique information of the copy destination medium and the unique information of the master medium are determined not to coincide with each other.

3. The copying apparatus according to claim 2,
wherein the unique information is memory capacity information of the memory medium, and
wherein, in the writing control process, it is determined whether memory capacity information of the copy destination medium and memory capacity information of the master medium coincide with each other, and the image file writing control or the writing control in units of files and folders is selectively performed based on a result of the determination.

4. The copying apparatus according to claim 1,
wherein, in the file/folder recognizing process, at least the files are recognized so as to be handled by the operating system as Read-Only when the data included in the image data file is recognized so as to be able to be handled in units of files and folders by the operating system.

5. The copying apparatus according to claim 1,
wherein the writing/reading unit is configured so as to be able to write and read data on and from a plurality of installed copy destination media in parallel, and
wherein, in the writing control process, the unique information of the copy destination media on which the writing/reading unit writes data is compared, and the image file writing control or the writing control in units of files and folders is selectively performed based on a result of the comparison.

6. A copying method for a copying apparatus that is used for copying data stored in a memory medium, which includes a memory unit storing the data therein and has a management data area in which unique information of the memory medium is stored and a user data area into which user data is written, as a master medium to the memory medium as a copy destination medium,
wherein the copying apparatus includes a reading/writing unit that writes or reads data on or from the installed copy destination medium and a control unit that is configured so as to perform a necessary control process by operating an operating system based on an application program,
the copying method comprising the steps of:
storing an image data file of the master medium and the unique information that is stored in the management data area of the master medium;
allowing data included in the image data file, which is stored by the memory means, to be recognized so as to be able to be handled by the operating system in units of files and folders; and
allowing the reading/writing unit to read out the unique information stored in the management data area of the copy destination media and selectively performing image file writing control, in which the image data file is controlled so as to be written on the copy destination medium, or writing control in units of files and folders, in which the data included in the image data file is written onto the copy destination medium in units of files and folders recognized by the operating system in the allowing of the reading/writing unit to read out the unique information, based on a result of comparison between the read-out unique information of the copy destination medium and the unique information of the master medium that is stored in the storing of an image data file of the master medium.

7. A memory medium on which data stored in a master medium is copied in accordance with a copying method using a copying apparatus that is used for copying data stored in a memory medium, which includes a memory unit storing the data therein and has a management data area in which unique information of the memory medium is stored and a user data area into which user data is written, as the master medium to the memory medium as a copy destination medium,
wherein the copying apparatus includes a reading/writing unit that writes or reads data on or from the installed copy destination medium and a control unit that is configured so as to perform a necessary control process by operating an operating system based on an application program,
the copying method including the steps of:
storing an image data file of the master medium and the unique information that is stored in the management data area of the master medium;
allowing data included in the image data file, which is stored in the storing of an image data file, to be recognized so as to be able to be handled by the operating system in units of files and folders; and
allowing the reading/writing unit to read out the unique information stored in the management data area of the copy destination media and selectively performing image file writing control, in which the image data file is controlled so as to be written on the copy destination medium, or writing control in units of files and folders, in which the data included in the image data file is written onto the copy destination medium in units of files and folders recognized by the operating system in the allowing of the reading/writing unit to read out the unique information, based on a result of comparison between the read-out unique information of the copy destination medium and the unique information of the master medium that is stored in the storing of an image data file of the master medium.

8. A program that is executed by a copying apparatus that is used for copying data stored in a memory medium, which includes a memory unit storing the data therein and has a management data area in which unique information of the memory medium is stored and a user data area into which user data is written, as a master medium to the memory medium as a copy destination medium,
wherein the copying apparatus includes a memory means for storing an image data file of the master medium and the unique information that is stored in the management data area of the master medium therein, a reading/writing unit that writes or reads data on or from the installed copy destination medium, and a control unit that is configured so as to perform a necessary control process by operating an operating system based on an application program,
the program allowing the control unit to perform:
a file/folder recognizing process that allows data included in the image data file, which is stored by the memory means, to be recognized so as to be able to be handled by the operating system in units of files and folders; and
a writing control process in which the writing/reading unit reads out the unique information stored in the management data area of the copy destination media, and image file writing control in which the image data file is controlled so as to be written on the copy destination medium or writing control in units of files and folders in which the data included in the image data file is written onto the copy destination medium in units of the files and the folders recognized by the operating system through the file/folder recognizing process is selectively performed based on a result of comparison between the read-out unique information of the copy destination medium and the unique information of the master medium that is stored in the memory means.
